(19) United States
(12) Patent Application Publication
(10) Pub. No.: US 2008/0129926 A1
(43) Pub. Date: Jun. 5, 2008

(54) Display device and method of displaying image using the same

(76) Inventors: Jeong-Min Seo, Gyeonggi-do (KR); Young-Bee Chu, Gyeonggi-do (KR); Dong-Cheol Kim, Gyeonggi-do (KR); Jong-Nam Lee, Gyeonggi-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/983,637

(22) Filed: Nov. 8, 2007

(30) Foreign Application Priority Data
Nov. 9, 2006 (KR) 2006-110308

(51) Int. Cl. G02F 1/13357; F21V 8/00

(52) U.S. Cl. 349/65; 362/618

(57) ABSTRACT

A display device includes a display panel part, a light source part and a light-controlling film. The display panel part includes a reflective pixel. The light source part includes a light source generating light and a light-guiding plate facing the display panel part and guiding the light from the light source to provide the light to the display panel part. The light-controlling film is disposed over the light-guiding plate to transmit a first light that is reflected by the reflective pixel and to block a second light that is obliquely leaked from the light-guiding plate. Thus, display quality of the display device may be improved in a reflective mode.

### CROSS-REFERENCE TO RELATED APPLICATIONS

This application claims the benefit of priority under 35 U.S.C. § 119 to Korean Patent Application No. 2006-110308, filed on Nov. 9, 2006 in the Korean Intellectual Property Office (KIPO), the contents of which are herein incorporated by reference in their entirety.

### BACKGROUND OF THE INVENTION

1. Technical Field

The present disclosure relates to a display device and a method of displaying an image using the display device. More particularly, the present disclosure relates to a reflective LCD display device and a method of displaying an image using the display device.

2. Discussion of the Related Art

Various types of flat panel displays are widely used in display devices. A liquid crystal display (LCD) device using a liquid crystal layer as a light shutter is particularly widely used.

LCD devices may be classified according to the type of pixels used, as either transmissive or reflective. A transmissive LCD device uses light internally provided by a backlight and a reflective LCD device uses light that is externally provided. Recently, the reflective LCD device has been studied in order to reduce power consumption and decrease the weight and volume of a display device, such as a mobile display device. However, the reflective LCD device may have low luminance, and may be unsuitable for use in certain locations. In order to overcome the deficiencies of the reflective LCD device, a front light-reflective LCD device, having a light source which is disposed at a front face of an LCD panel, has been developed.

A front light unit of the reflective LCD device may include a light source and a light-guiding plate for guiding the light from the light source and providing the guided light to a display panel. A portion of the light that enters the light-guiding plate may exit obliquely through an upper face of the light-guiding plate instead of being guided to the display panel. This leaked light is not polarized and does not include image information because the leaked light is not reflected from the display panel. Thus, the leaked light decreases the contrast ratio of an image and degrades the display quality.

The front light unit may be employed in a two-way LCD display device of a mobile display device such as a cellular phone. The two-way LCD display device displays two images, one image on each of the opposite faces of one display panel by using the front light unit. Light generated by the front light unit of the two-way display device is reflected by the display panel and also passes through the display panel. In the two-way LCD display, leaked light decreases the contrast ratio in the reflective mode of the display.

### SUMMARY OF THE INVENTION

Exemplary embodiments of the present invention provide a display device in which leaked light is blocked by a light controlling film.

Exemplary embodiments of the present invention also provides a method of displaying an image using the display device.

In one exemplary embodiment of the present invention, a display device includes a display panel part, a light source part and a light-controlling film. The display panel part includes a reflective pixel. The light source part includes a light source for generating light and a light-guiding plate, facing the display panel part, for guiding the light from the light source to provide the light to the display panel part. The light-controlling film is disposed over the light-guiding plate to transmit a first light that is reflected by the reflective pixel and to block a second light that is obliquely leaked from the light-guiding plate.

The light-controlling film includes a transparent resin layer and a plurality of light-blocking layers. The transparent resin layer faces the light-guiding plate. The light-blocking layers are arranged substantially in parallel with each other in the transparent resin layer and form a predetermined angle with respect to the light-guiding plate, to block the second light. The light-blocking layers may be disposed substantially in parallel with a side surface of the light-guiding plate. The display panel part may further include a first substrate having the reflective pixel, a second substrate having a color filter and a liquid crystal layer interposed between the second substrate and the first substrate. The display device may further include a first display window disposed over the light-guiding plate. A first image is displayed through the first display window by using the first light. The light-controlling film may be attached to the first display window.

The display panel part may further include a transmissive pixel formed on the first substrate. The reflective pixel and the transmissive pixel may be alternately formed on the first substrate. The display device may further include a second display window disposed under the display panel part. A second image is displayed through the second display window by using a third light that passes through the transmissive pixel.

The light-guiding plate may include a side face, a light-exiting face, a light-guiding face and a counter face. The side face receives the light generated from the light source. The light-exiting face faces the display panel part and is connected to the side face. The light-guiding face faces the light-exiting face and has a prism pattern. The counter face faces the side face. The prism pattern may include a first inclined face and a second inclined face. The first inclined face forms a first angle in a clockwise direction with respect to the light-exiting face. The first inclined face reflects the light provided from the light source part toward the display panel part. The second inclined face forms a second angle that is smaller than the first angle in a counterclockwise direction with respect to the light-exiting face and is connected to the first inclined face. The second inclined face transmits the first light. The first inclined face and the second inclined face may extend in a longitudinal direction of the side face. The light source may include a point light source and a light-guiding bar. The point light source generates the light. The light-guiding bar includes a light-receiving face receiving the light from the point light source and a light-providing face facing the side face of the light-guiding plate and being connected to the light-receiving face. The light-guiding bar may further include an upper face connected to the light-receiving face and the light-providing face, a lower face connected to the light-receiving face and the light-providing face, the lower face facing the upper face, and a refractive patterned face facing the light-providing face and having a reflective pattern reflecting the light incident from the point light source toward the light-providing face. The light source part may further include a reflective cover covering the upper face, the refractive patterned face, and the lower face.

In another exemplary embodiment of the present invention, a method of displaying an image is provided as follows. Light is provided to a light-guiding plate. The light is reflected from a first inclined face toward a display panel. The reflected light reflected from the display panel to generate a first light. The first light is transmitted through a second inclined face toward a light-controlling film to display a first image. A second light obliquely leaked from the light-guiding plate is blocked using the light-controlling film.

According to the above, the display quality of a front light type display device may be improved in a reflective mode by using a light controlling film to block light that is obliquely leaked from a light-guiding plate.

### BRIEF DESCRIPTION OF THE DRAWINGS

The patent or application file contains at least one drawing executed in color. Copies of this patent or patent application publication with color drawings will be provided by the U.S. Patent and Trademark Office upon request and payment of the necessary fee.

The above and other features and advantages of the present invention will become more apparent from the following detailed description of exemplary embodiments of the present invention, taken in conjunction with the accompanying drawings, in which:

FIG. 1 is an exploded perspective view of a display device according to an exemplary embodiment of the present invention;

FIG. 2 is a cross-sectional view taken along a line I-I′ in FIG. 1;

FIG. 3 is a cross-sectional view of the display panel part of the display device of FIG. 2;

FIG. 4 is a plan view of a portion of the first substrate of the display panel part of FIG. 3;

FIG. 5 is a graph showing an amount of light that exits the light-guiding face of the light-guiding plate when the light-guiding-plate is tested without a display panel;

FIG. 6 is a graph showing a horizontal amount of light that exits the light-guiding face of the light-guiding plate when the light guiding-plate is tested without a display panel;

FIG. 7 is a graph showing a vertical amount of light that exits the light-guiding face of the light-guiding plate when the light-guiding plate is tested without a display panel;

FIG. 8 is a perspective view of the light-controlling film of the display device of FIG. 1;

FIG. 9 is a cross-sectional view taken along a line II-II′ in FIG. 8;

FIG. 10 is a graph showing an amount of light that exits the light-controlling film when the light-guiding plate is tested without a display panel;

FIG. 11 is a graph showing a vertical amount of light that exits the light-controlling film when the light-guiding plate is tested without a display panel;

FIG. 12 is a cross-sectional view of a display device according to another exemplary embodiment of the present invention; and

FIG. 13 is a cross-sectional view of the display panel part of the display device of FIG. 12.

### DESCRIPTION OF THE EMBODIMENTS

Exemplary embodiments of the invention are described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

Display Device

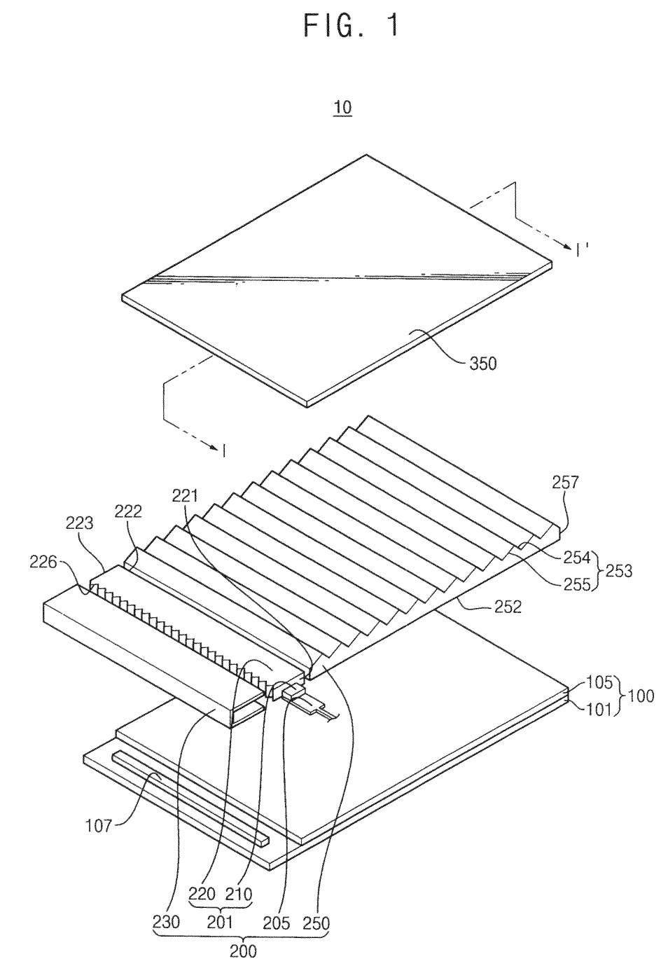

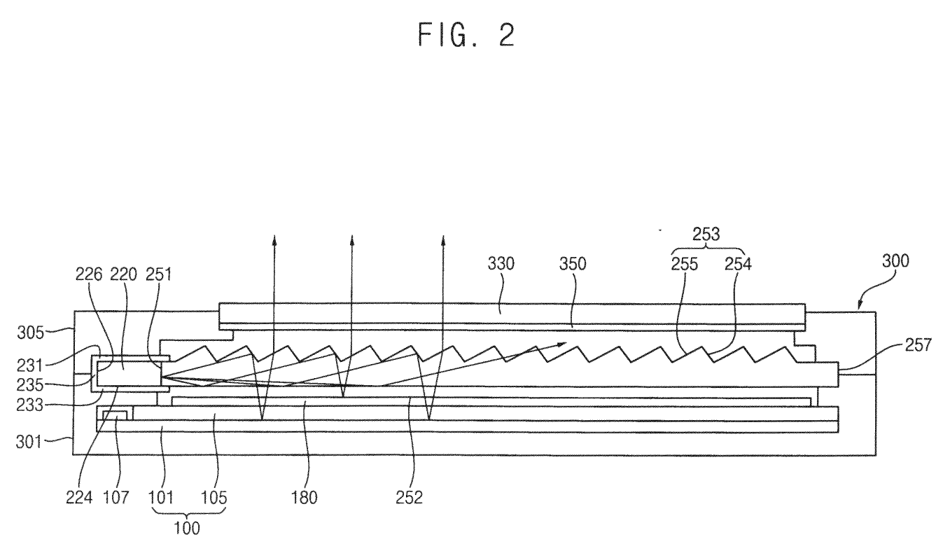

FIG. 1 is an exploded perspective view of a display device according to an exemplary embodiment of the present invention. FIG. 2 is a cross-sectional view taken along a line I-I′ in FIG. 1.

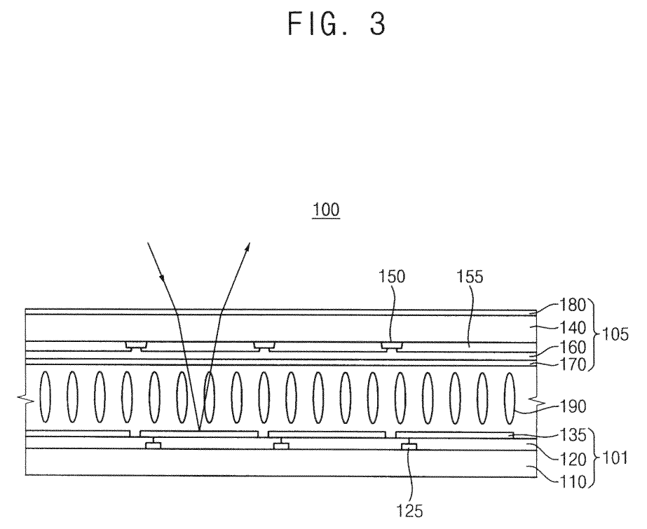

Referring to FIG. 1, the display device 10 is a reflective LCD display device and includes a display panel part 100, a light source part 200 and a light-controlling film 350. The display panel part 100 includes a first substrate 101 having a plurality of reflective pixels, a second substrate 105 facing the first substrate 101 and a liquid crystal layer 190 (shown in FIG. 3) interposed between the first substrate 101 and the second substrate 105. The light source part 200 will be described first and the display panel part 100 will be described in detail later.

Hereinafter, the terms “upper” and “upwardly” are used to correspond to a direction from the first substrate 101 toward the second substrate 105, and the terms “lower” and “downwardly” are used to correspond to a direction from the second substrate 105 toward the first substrate 101.

The light source part 200 is a front light unit and is disposed over the display panel part 100. The reflective pixels reflect light provided from the light source part 200. The light reflected by the reflective pixels is herein called a first light that is used to display a first image. The light-controlling film 350 improves the quality of the image by transmitting the first light while blocking light leaked from the light source part 200.

Referring to FIGS. 1 and 2, the light source part 200 provides light to the display panel part 100. In an exemplary embodiment, the light source part 200 includes a light source 201 and a light-guiding plate 250.

The light source 201 includes a point light source 210 and a light-guiding bar 220.

The point light source 210 may include a white light-emitting diode (LED) that emits white light.

The light-guiding bar 220 may have, for example, a substantially rectangular parallelepiped shape. The light-guiding bar 220 may include a light guiding material having excellent characteristics in optical transmissivity, heat resistance, chemical resistance, and mechanical strength. Examples of a light guiding material that may be used for the light-guiding bar 220 include polymethyl methacrylate, polyamide, polyimide, polypropylene, and polyurethane. These materials can be used alone or in combination.

The light-guiding bar 220 converts the point light source 210 into a planar light source. The light-guiding bar 220 includes a light-receiving face 221, a light-providing face 222, a refractive patterned face 226, an upper face 223 and a lower face 224.

The point light source 210 is disposed adjacent to the light-receiving face 221 to provide light to the light-receiving face 221. The light-providing face 222 and the refractive patterned face 226 face each other, and are connected to the light-receiving face 221. The upper face 223 and the lower face 224 face each other, and are connected to the light-receiving face 221, the light-providing face 222 and the refractive patterned face 226. The refractive patterned face 226 has a reflective pattern such as a prism pattern. Light entering the light-receiving face 221 is repeatedly reflected in the light-guiding bar 220, and thus is reflected by the refractive patterned face 226 to exit the light-guiding bar 220 through the light-providing face 222.

The light source part 200 may further include a power supply board 205 and a reflective cover 230.

The power supply board 205 may include a flexible printed circuit board (FPCB). The point light source 210 is mounted on the power supply board 205. The power supply board 205 applies a driving voltage from an externally provided power source part to the point light source 210.

The reflective cover 230 reflects light from the light-guiding bar 220 so that the light reenters the light-guiding bar 220. The reflective cover 230 covers the upper face 223, the refractive patterned face 226, and the lower face 224 of the light-guiding bar 220. The reflective cover 230 may include a first face 231 covering the upper face 223 of the light-guiding bar 220, a second face 233 covering the lower face 224 of the light-guiding bar 220 and a third face 235 covering the refractive patterned face 226 of the light-guiding bar 220.

The light-guiding plate 250 guides light from the light-providing face 222 of the light-guiding bar 220 to provide guided light to the display panel part 100. The light-guiding plate 250 may include a light guiding material such as polymethyl methacrylate, polyamide, polimide, polypropylene, or other suitable materials as listed herein above as suitable for use in the light-guiding bar 220.

The light-guiding plate 250 may include a side face 251, a counter face 257, a light-exiting face 252 and a light-guiding face 253.

The side face 251 faces the light-providing face 222 of the light-guiding, bar 220. The light-exiting face 252 faces the second substrate 105 of the display panel part 100, and is connected to the side face 251. The light-guiding face 253 faces the light-exiting face 252, and is connected to the side face 251 and the counter face 257. The light-guiding face 253 has a prism pattern.

Light enters the light guiding plate 250 through the side face 251 and undergoes internal reflections within the light guiding plate 250, in which the light is reflected by the light-guiding face 253, by the light-exiting face 252 and by the counter face 257. The light-guiding face 253 reflects the light toward the light-exiting face 252 where the light exits the light guiding plate and enters the display panel part 100. A first light that is reflected from reflective pixels in the display panel part 100, passes into the light-guiding plate 250, and exits the light-guiding plate 250 through the light-guiding face 253.

The light-guiding face 253 may have, for example, a prism pattern as shown in FIGS. 1 and 2. The prism pattern extends in a longitudinal direction of the side face 251. Since the light-guiding face 253 has a prism pattern, the light-guiding face 253 may include two inclined faces facing each other, a first inclined face 254 and a second inclined face 255.

As shown in FIG. 2, the first inclined face 254 reflects light that is incident through the side face 251 to the display panel part 100. The first inclined face 254 forms a first angle in a clockwise direction with respect to the light-exiting face 252. Thus, the first inclined face 254 obliquely faces the side face 252. The first angle may be determined by an experiment so that the first inclined face 254 may effectively reflect the incident light to the display panel part 100.

The second inclined face 255 transmits the first light. The first light upwardly exits the light-guiding plate 250 through the light-guiding face 253. The second inclined face 255 forms a second angle that is smaller than the first angle in a counterclockwise direction with respect to the light-exiting face 252. Thus, the second inclined face 255 obliquely faces the counter face 257, and is connected to the first inclined face 254. The second angle may be determined by an experiment so that the first light may effectively exit the light-guiding plate 250 through the second inclined face 255.

The display device 10 may further include a receiving container 300 and a display window 330. The receiving container 300 may include a lower receiving container 301 and an upper receiving container 305.

The lower receiving container 301 includes a bottom plate and a sidewall protruding from a peripheral portion of the bottom plate. The display panel part 100 is disposed on the bottom plate. A first stepped portion is formed at an upper portion of the sidewall. The reflective cover 230 is disposed on the stepped portion, and the reflective cover 230 receives the light-guiding bar 220. A first edge portion of the light-guiding plate 250 is inserted into the reflective cover 230. A second edge portion of the light-guiding plate 250 is supported by a second stepped portion of the sidewall.

An opening for displaying an image is formed through the upper receiving container 305. The upper receiving container 305 is coupled to the lower receiving container 301 with the light source part 200 being held in place between the upper receiving container 305 and the lower receiving container 301.

The display window 330 covers the opening formed through the upper receiving container 305. The display window may include resin, or glass or other material having excellent optical transmissivity. The light-controlling film 350 may be disposed on the display window 330. For example, the light-controlling film 350 may be adhered to a rear surface of the display window 330.

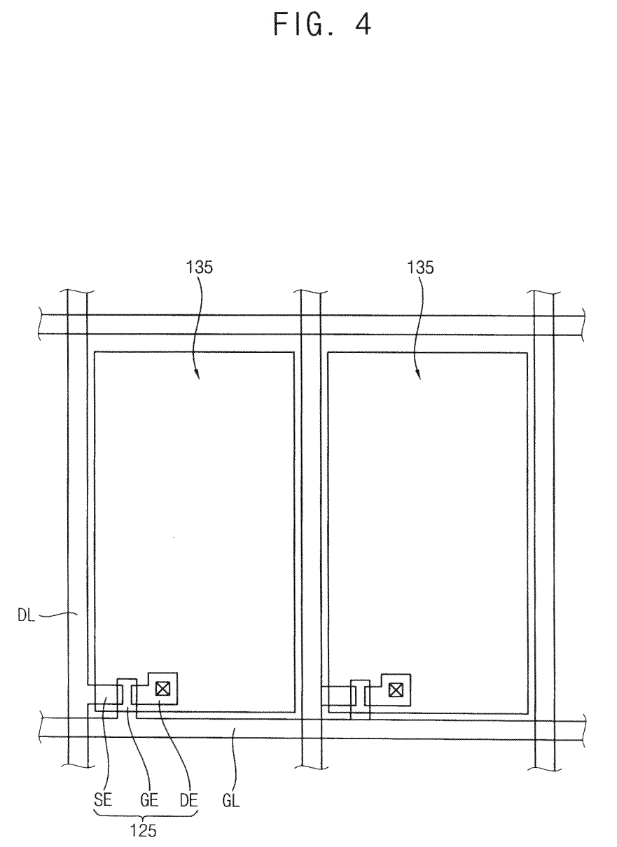

FIG. 3 is a cross-sectional view showing the display panel part of the display device of FIG. 2. FIG. 4 is a plan view showing a portion of the first substrate of the display panel part of FIG. 3.

The display panel part 100 includes the first substrate 101, the second substrate 105 and the liquid crystal layer 190.

The first substrate 101 may include a lower base substrate 110, a thin-film transistor (TFT) layer 120 and a reflective pixel 135.

The lower base substrate 110 may include, for example, glass that is optically isotropic. The TFT layer 120 may include signal lines for applying pixel voltages to the reflective pixel 135 and a switching element 125. The signal lines include a data line DL for applying the pixel voltage, and a gate line GL for applying a gate signal controlling the switching element 125. The gate line GL and the data line DL are insulated from each other by a gate insulation layer, and cross each other. The gate line GL and the data line DL define a unit pixel area.

The switching element 125 may include a source electrode SE electrically connected to the data line DL, a gate electrode GE electrically connected to the gate line GL and a drain electrode DE electrically connected to the reflective pixel 135.

The reflective pixel 135 is disposed on the TFT layer 120 in the unit pixel area. The reflective pixel 135 may include, for example, a metal thin film having excellent optical reflectivity such as an aluminum thin film.

The first substrate 101 may further include a driving part 107 for outputting a pixel voltage and a gate signal. The driving part 107 may be an integrated circuit chip, and may be mounted on a non-display area of the first substrate 101.

The second substrate 105 may include an upper base substrate 140 facing the lower base substrate 110, a light-blocking pattern 150, a color filter portion 155, a protective layer 160 and a common electrode 170.

The upper base substrate 140 may include, for example, glass. The light-blocking pattern 150 may be formed on the upper base substrate 140 in a matrix shape corresponding to the gate line GL and the data line DL. The light-blocking pattern 150 may include a chromium group metal or organic material.

The color filter portion 155 may include red, green and blue color filters. The color filters correspond to the unit pixel area and are disposed between of light-blocking patterns 150. The protective film 160 covers the color filter portion 155 and protects the color filter portion 155. Examples of a transparent conductive material that may be used for the common electrode 170 include indium tin oxide (ITO) and indium zinc oxide (IZO). These may be used alone or in a combination thereof.

The liquid crystal layer 190 is interposed between the first substrate 101 and the second substrate 105. Liquid crystal molecules of the liquid crystal layer 190 are rearranged by an electric field between the reflective pixel 135 and the common electrode 170, thereby controlling the polarization of the light passing through the liquid crystal layer 190.

The display panel part 100 may further include a polarizing plate 180 disposed on the second substrate 105.

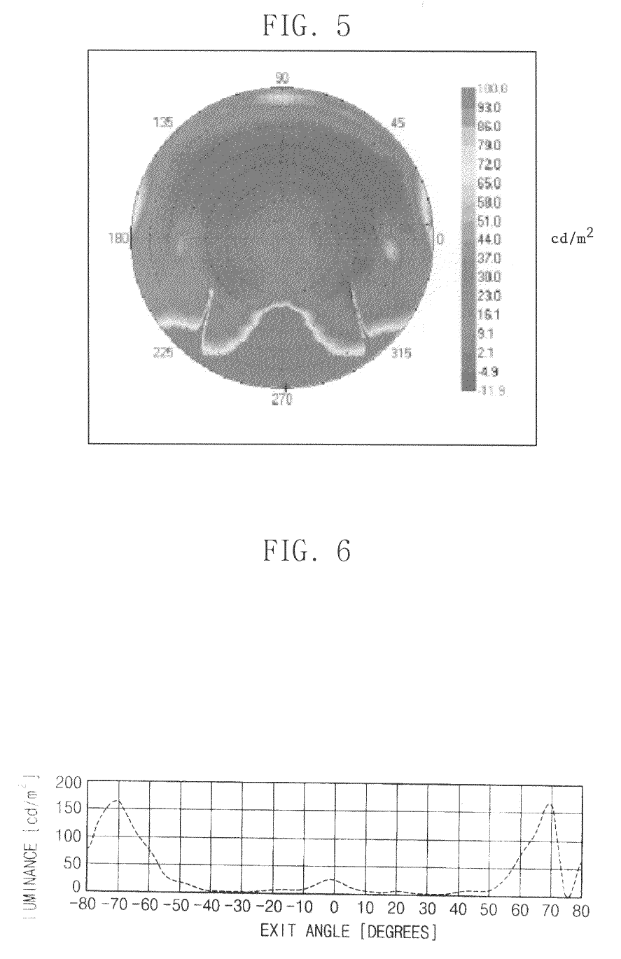

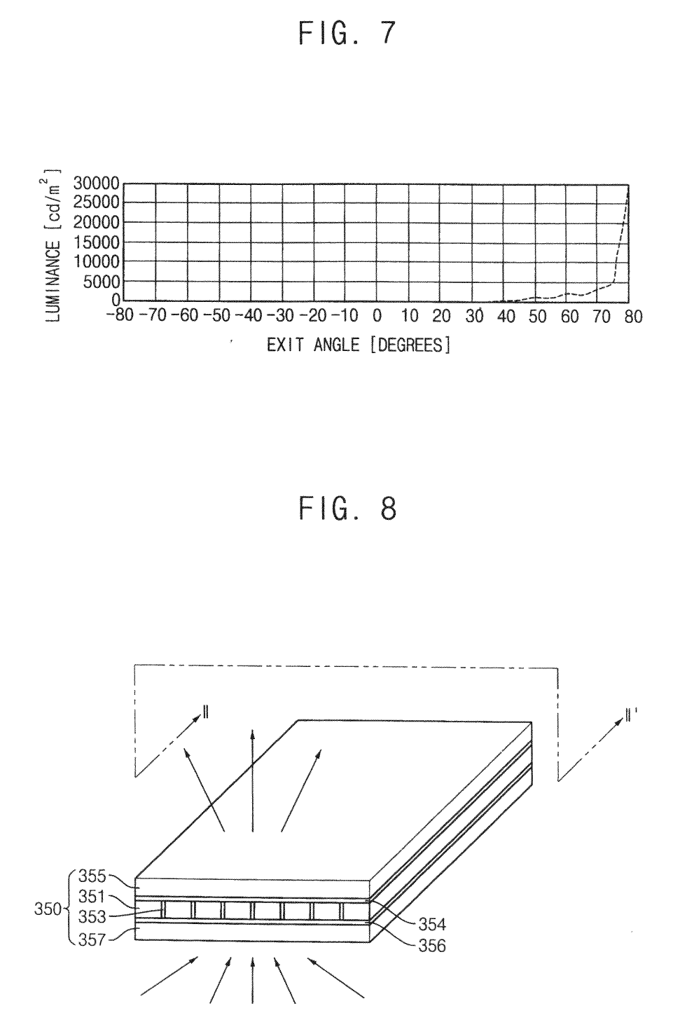

FIGS. 5, 6 and 7 are graphs showing front luminance or the amount of light output at the light-guiding face 253 of the light-guiding plate 250 when light from the light source 201 enters the light-guiding plate and, with the display panel 100 removed, there is no light reflected from a display panel. FIG. 5 is a graph showing an amount of light that exits the light-guiding face of the light-guiding plate illustrated in FIG. 1. FIG. 6 is a graph showing a horizontal amount of light that exits the light-guiding face of the light-guiding plate illustrated in FIG. 1. FIG. 7 is a graph showing a vertical amount of light that exits the light-guiding face of the light-guiding plate illustrated in FIG. 1.

FIG. 5 shows front luminance of light exiting the light-guiding plate 250 that excludes the display panel part 100. In FIG. 5, a position at 90 degrees of a circular graph corresponds to the side face 251 of the light-guiding plate 250, at which the light source 201 is disposed. In FIG. 5, a position at 270 degrees of the circular graph corresponds to the counter face 257 of the light-guiding plate 250. In FIG. 5, colors of the circular graph represent luminance of the light exiting the light-guiding plate 250.

Referring to FIGS. 2 and 5, light entering the light-guiding plate 250 is reflected by the first inclined face 254 of the light-guiding face 253 to exit the light-guiding plate 250 through the light-exiting face 252. A portion of the light entering the light-guiding plate 250 may not exit the light-guiding plate 250 through the light-exiting face 252, but may be obliquely leaked from the light-guiding plate 250 through the light-guiding face 253. As shown in FIG. 2, the leaked light travels along a direction from the side face 251 to a place over the counter face 257. Thus, referring to the graph in FIG. 5, luminance of positions at about 225 degrees to about 315 degrees is greater than that of other positions.

FIG. 6 shows luminance of light exiting the light-guiding plate 250 when a viewing angle varies along a longitudinal direction of the side face 251, that is, an extending direction of the prism pattern formed on the light-guiding face 253. In FIG. 6, a position at 0 degree corresponds to the front of the light-guiding plate 250.

Referring to FIG. 6, when the viewing angle is in a range of about −50 degrees to about +50 degrees, little light exits the light-guiding plate 250. In contrast, when the viewing angle is in a range of about ±50 degrees to about ±80 degrees, the amount of light that exits the light-guiding plate 250 greatly increases, since the light that enters the light-guiding plate 250 through the side face 251 is repeatedly reflected in the light-guiding plate 250, thereby increasing a horizontal component of light. Since the amount of light that exits the light-guiding plate 250 greatly increases at the viewing angle of about ±50 degrees to about ±80 degrees, little light exits the light-guiding plate 250 in a front direction, and obliquely leaked light exists.

FIG. 7 shows luminance of light exiting the light-guiding plate 250 when a viewing angle, or exit angle in FIG. 7, varies along a direction from the side face 251 toward the counter face 257. In FIG. 7, a negative angle corresponds to a position adjacent to the side face 251 at which the light source is disposed 201, and a positive angle corresponds to a position adjacent to the counter face 257. In other words, In FIG. 7 a negative exit angle corresponds to a light exit direction from the light-guiding plate towards the side face 251, and a positive exit angle corresponds to a light exit direction from the light-guiding palate towards the counter face 257.

Referring to FIG. 7, when the viewing angle is in a range of about −80 degrees to about +50 degrees, little light exits the light-guiding plate 250. In contrast, when the viewing angle is in a range of about +50 degrees to about +80 degrees, the amount of light that exits the light-guiding plate 250 greatly increases. Thus, the fact that the light that enters through the side face 251 is typically toward the counter face 257 and some light is not reflected by the first inclined face 254 but obliquely leaked may be inferred from the above results.

As described above, the light that enters through the side face 251 and is obliquely leaked through the light-guiding face 253, which does not exit the light-guiding plate 250 through the light-exiting face 252, is defined as a second light. The second light is not polarized since the second light does not pass through the display panel part 100, and does not include image information. Thus, the second light reduces the contrast ratio of an image and decreases display quality of the reflective type display device 10.

The function of the light-controlling film will be described in detail with reference to FIGS. 8, 9, 10, and 11.

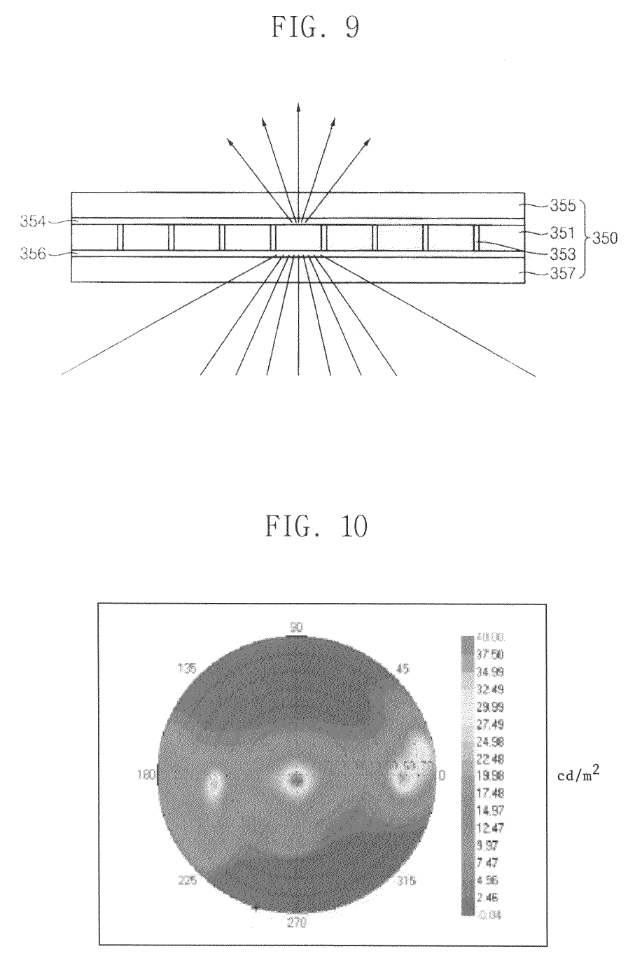

FIG. 8 is a perspective view of a light-controlling film of the display device of FIG. 1. FIG. 9 is a cross-sectional view taken along a line II-II′ in FIG. 8.

Referring to FIGS. 1, 8 and 9, the light-controlling film 350 is disposed over the light-guiding plate 250. The light-controlling film 350 transmits the first light reflected from the reflective pixel 135, and blocks the second light.

The light-controlling film 350 may include a transparent resin layer 351 and a plurality of light-blocking layers 353.

The transparent resin layer 351 may include resin having excellent optical transmissivity and optical isotropy. The light-blocking layers 353 are disposed in the transparent resin layer 351 and integrally formed with the transparent resin layer 351. The light-blocking layers 353 may be disposed in the longitudinal direction of the side face 251, for example, substantially in parallel with the side face 251 of the light-guiding plate 251. In an exemplary embodiment, the light-blocking layers 353 are substantially perpendicular to the light-guiding plate 250, and spaced apart from each other at a regular distance.

The light-blocking layers 353 may reflect most of the light having an angle of incidence greater than a critical angle. The light-blocking layers 353 may absorb most of light having an angle of incidence smaller than the critical angle.

Most of the first light may have an angle of incidence greater than the critical angle. Thus, the first light may pass through the light-controlling film 350. As shown in FIGS. 8 and 9, the first light may pass through the light-controlling film 350, with an optical path being maintained, or may pass through the light-controlling film 350 after being reflected by the light-blocking layers 353. Thus, the light-controlling film 350 may not degrade viewing angle characteristics of the first light.

As shown in FIGS. 2, 8 and 9, most of the second light may be incident into the light-blocking layers 353 with an angle of incidence smaller than the critical angle. Thus, most of the second light may be absorbed in the light-blocking layers 353. Unabsorbed light of the second light may be reflected by the light-blocking layers 353 and upwardly exit the light-controlling film 350. Here, the second light may have a scattered reflection from the light-blocking layers 353. Thus, an optical path of the second light may be closer to a front direction than an optical path before the second light is incident into the light-controlling film 350.

Alternatively, the light-controlling film 350 may include a light-reflective layer replacing each of the light-blocking layers 353. Alternatively, the light-controlling film 350 may include the light-blocking layers 353 and a light-reflective layer formed on the light-blocking layers 353. Alternatively, the display device 10 may include a light condensing sheet replacing the light-controlling film 350.

The light-controlling film 350 may further include protective layers 355 and 357. The protective layers 355 and 357 are disposed on a front face of the transparent resin layer 351 and a rear face of the transparent resin layer 351, respectively, wherein the rear face of the transparent resin layer faces the light-guiding face 253.

The light-controlling film 350 may further include adhesive layers 354 and 356 interposed between the protective layers 355 and 357 and the transparent resin layer 351, respectively.

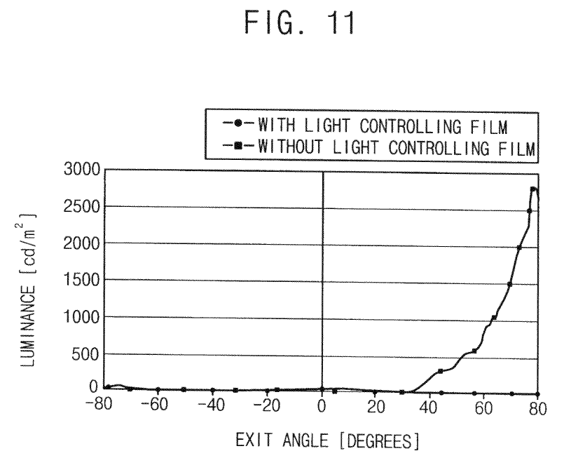

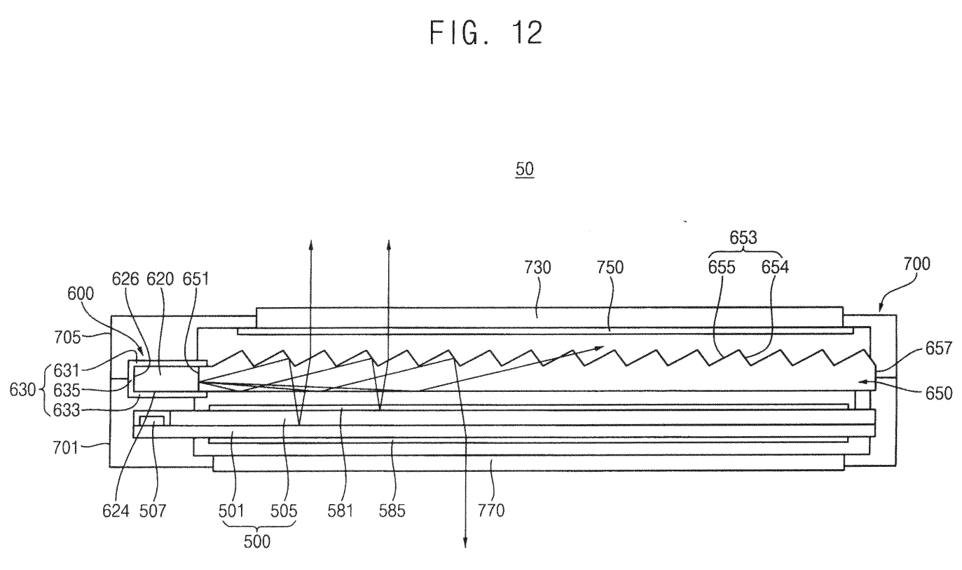

FIG. 10 is a graph showing an amount of light exiting the light-controlling film illustrated in FIG. 1. FIG. 11 is a graph showing a vertical amount of light exiting the light-controlling film illustrated in FIG. 1.

The display panel 100 is removed for the purposes of making the measurements that are summarized in FIG. 10.

Referring to FIG. 10, when the viewing angle is in a range of about 225 degrees to about 315 degrees, little light exits the light-guiding plate 250. Since the light-blocking layers 353 of the light-controlling film 350 are disposed in the longitudinal direction of the side face 251, most of the second light may be blocked.

The light-blocking layers 353 partially change an optical path of unabsorbed light of the second light to have a direction close to the front direction. Thus, luminance of exiting light at a position corresponding to 0 degree to 180 degrees is increased. Since the second light is blocked, the luminance of the exiting light is decreased by about 2.3 percent.

As described above, the light-controlling film 350 blocks the second light while the light-controlling film 350 has little influence on the first light. Thus, decreased luminance in the front direction may be negligible, and reduction of the contrast ratio of an image may be prevented, thereby improving display quality.

FIG. 11 shows luminance versus exit angle for vertical light, both with and without a light-controlling film, wherein vertical light is in the vertical direction of FIG. 5 and FIG. 10, and a negative exit angle corresponds to light exiting towards the side face 251 and a positive exit angle corresponds to light exiting towards the counter face 257. With the light-controlling film 350 in place, the luminance remains very low at all exit angles from 80 degrees to +80 degrees.

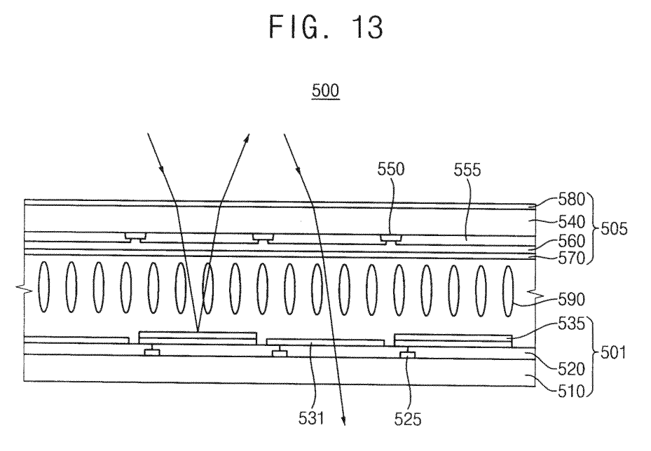

FIG. 12 is a cross-sectional view of a display device according to an exemplary embodiment of the present invention. FIG. 13 is a cross-sectional view of the display panel part of the display device of FIG. 12.

Referring to FIGS. 12 and 13, a display device 50 includes a display panel part 500, a light source part 600 and a light-controlling film 750. The display device 50 is substantially the same as the display device 10 shown in FIGS. 1 and 2 except for the display panel part 500.

In an exemplary embodiment, the display device 50 upwardly and downwardly displays images. The display panel part 500 includes a second substrate 505, a first substrate 501 and a liquid crystal layer 590. The display panel part 500 is substantially the same as the display panel part 100 shown in FIGS. 1 and 2 except for the first substrate 501.

The first substrate 501 is substantially the same as the first substrate 101 shown in FIG. 2 except that the first substrate 501 further includes a transmissive pixel 531 and a lower polarizing plate 585. The first substrate 501 may include a lower base substrate 510, a TFT layer 520, a reflective pixel 535 and a transmissive pixel 531.

The TFT layer 520 may include signal lines for applying pixel voltages to the reflective pixel 135 and to a switching element 525. A gate line and a data line define a unit pixel area, and the reflective pixel 535 and the transmissive pixel 531 are formed in the unit pixel area.

The reflective pixel 535 and the transmissive pixel 531 may be alternately arranged in a line, or may be formed in a predetermined pattern. The reflective pixel 535 may include, for example, a metal thin film having excellent optical reflectivity such as aluminum. Examples of transparent conductive materials that can be used for the transmissive pixel 531 include ITO and IZO. These can be used alone or in a combination thereof.

The switching element 525 may include a source electrode electrically connected to the data line, a gate electrode electrically connected to the gate line and a drain electrode electrically connected to the reflective pixel 535 or the transmissive pixel 531.

The reflective pixel 535 and the transmissive pixel 531 are formed on the TFT layer 520 in unit pixel areas. The reflective pixel 535 and the transmissive pixel 531 independently receive the pixel voltages.

Accordingly, the display device 50 displays a first image by using a first light that sequentially passes through a light-guiding plate 650, the second substrate 505, the liquid crystal layer 590, is reflected by the reflective pixel 535, and then sequentially passes through the liquid crystal layer, the second substrate 505, the light-guiding plate 650, and the light controlling layer 750 to upwardly exit the display device 50. The light-controlling film 750 blocks a second light that is not guided to the display panel part 500 but is upwardly obliquely leaked. The display device 50 displays a second image by using a third light that sequentially passes through the light-guiding plate 650, the second substrate 505, the liquid crystal layer 590 and the transmissive pixel 531 to downwardly exit the display device 50.

The lower polarizing plate 585 is disposed on a rear face of the first substrate 501.

The display device may further include a lower receiving container 701, an upper receiving container 705, a first display window 730 and a second display window 770.

The lower receiving container 701 is substantially the same as the lower receiving container 301 shown in FIG. 2 except for an opening formed through a bottom plate. The display panel part 500 may be supported by the bottom plate. A light source and the light-guiding plate 650 are supported by a stepped portion formed at a sidewall of the lower receiving container 701. The upper receiving container 705 is substantially the same as the upper receiving container 305 illustrated in FIG. 2. Thus, the second substrate 505 is upwardly exposed, and the first substrate 501 is downwardly exposed.

The first display window 730 covers an opening formed through the upper receiving container 705. The second display window 770 covers the opening formed through the bottom plate of the lower receiving container 701. Thus, the first and second images are displayed on the first and second display windows 730 and 770, respectively.

The light-controlling film 750 may be disposed on a rear surface of the first display window 730.

According to the present invention, a light-controlling film transmits light reflected by a reflective electrode without changing characteristics of the reflected light. In contrast, the light-controlling film blocks light that is not guided to a display panel part and is obliquely leaked over the light-guiding plate. In addition, front luminance is decreased by a negligible amount. Thus, the contrast ratio of an image in a reflective mode may be enhanced to thereby improve display quality.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display device comprising:
a display panel part comprising a reflective pixel;
a light source part comprising:
a light source for generating light; and
a light-guiding plate facing the display panel part and guiding the light from the light source to provide the display panel part with the light; and
a light-controlling film disposed over the light-guiding plate to transmit a first light that is reflected from the reflective pixel and to block a second light that is obliquely leaked from the light-guiding plate.

2. The display device of claim 1, wherein the light-controlling film comprises:
a transparent resin layer facing the light-guiding plate; and
a plurality of light-blocking layers arranged substantially in parallel with each other in the transparent resin layer and forming a predetermined angle with respect to the light-guiding plate, to block the second light.

3. The display device of claim 2, wherein the light-blocking layers are disposed substantially in parallel with a side surface of the light-guiding plate.

4. The display device of claim 1, wherein the display panel part displays a first image and a second image in opposite directions.

5. The display device of claim 1, wherein the display panel part comprises:
a first substrate having the reflective pixel;
a second substrate; and
a liquid crystal layer interposed between the first substrate and the second substrate.

6. The display device of claim 5, further comprising a first display window disposed opposite to the display panel part with respect to the light-guiding plate, a first image being displayed through the first display window by using the first light.

7. The display device of claim 6, wherein the light-controlling film is attached to the first display window.

8. The display device of claim 6, wherein the first substrate further comprises a transmissive pixel.

9. The display device of claim 8, further comprising a second display window disposed opposite to the light-guiding plate with respect to the display panel part, the second image being displayed through the second display window by using a third light that passes through the transmissive pixel.

10. The display device of claim 1, wherein the light-guiding plate comprises:
a side face for receiving the light generated from the light source;
a light-exiting face facing the display panel part and being connected to the side face;
a light-guiding face facing the light-exiting face and having a prism pattern; and
a counter face facing the side face.

11. The display device of claim 10, wherein the prism pattern comprises:
a first inclined face forming a first angle in a clockwise direction with respect to the light-exiting face; and
a second inclined face forming a second angle that is smaller than the first angle in a counterclockwise direction with respect to the light-exiting face and being connected to the first inclined face.

12. The display device of claim 11, wherein the first inclined face and the second inclined face extend in a longitudinal direction of the side face.

13. The display device of claim 10, wherein the light source comprises:
a point light source for generating the light; and
a light-guiding bar comprising:
a light-receiving face for receiving the light from the point light source; and
a light-providing face facing the side face of the light-guiding plate and being connected to the light-receiving face.

14. The display device of claim 13, wherein the light-guiding bar further comprises:
an upper face connected to the light-receiving face and the light-providing face;
a lower face connected to the light-receiving face and the light-providing face, the lower face facing the upper face; and
a refractive patterned face facing the light-providing face and having a reflective pattern reflecting the light generated from the point light source toward the light-providing face.

15. The display device of claim 14, wherein the light source part further comprises a reflective cover covering the upper face, the refractive patterned face, and the lower face.

16. A method of displaying an image, comprising:
providing light to a light-guiding plate;
reflecting the light from a first inclined face toward a display panel;
reflecting the reflected light from the display panel to generate a first light;
transmitting the first light through a second inclined face toward a light-controlling film to display a first image; and
blocking a second light obliquely leaked from the light-guiding plate using the light-controlling film.

17. The method of claim 16, wherein the first inclined face has a first angle, and the second inclined face has a second angle that is smaller than the first angle.

18. The method of claim 16, further comprising transmitting a portion of the reflected light through the display panel to generate a second image.

19. The method of claim 16, wherein providing light to a light-guiding plate comprises:
generating the light from a point light source as a point shape; and
changing the light into a linear light.

20. The method of claim 19, wherein the linear light is generated using a light guiding bar.
